(19) United States
(12) Patent Application Publication
(10) Pub. No.: US 2006/0291746 A1
(43) Pub. Date: Dec. 28, 2006

(54) Method of and apparatus for removing color noise based on correlation between color channels

(75) Inventors: Moon-gi Kang, Goyang-si (KR); Min-kyu Park, Seoul (KR); Chang-won Kim, Seoul (KR); Young-seok Han, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/471,502

(22) Filed: Jun. 21, 2006

(30) Foreign Application Priority Data
Jun. 21, 2005 (KR) 10-2005-0053611

(51) Int. Cl. G06K 9/40; H04N 5/228

(52) U.S. Cl. 382/275; 382/260; 348/222.1

(57) ABSTRACT

A method of and apparatus for removing color noise are provided. The apparatus includes a first filtering unit, a subtracting unit, a second filtering unit, and an adding unit. The first filtering unit removes color noise from color data of a first channel among input interpolated color data and outputs filtered color data of the first channel. The subtracting unit calculates a difference between each of input color data of a second channel and a third channel among the input interpolated color data and the filtered color data of the first channel and outputs differential images. The second filtering unit selects an intermediate differential image among the output differential images and previously filtered differential images and outputs filtered differential images. The adding unit adds the filtered color data of the first channel and the filtered differential images and outputs filtered color data of the second channel and the third channel.

### CROSS-REFERENCE TO RELATED PATENT APPLICATION

This application claims priority from Korean Patent Application No. 10-2005-0053611, filed on Jun. 21, 2005, in the Korean Intellectual Property Office, the disclosure of which is incorporated herein in its entirety by reference.

### BACKGROUND OF THE INVENTION

1. Field of the Invention

Methods and apparatuses consistent with the present invention relate to processing an image, and more particularly, to removing the color noise of input red/green/blue (RGB) data that is output from an image sensor and is then interpolated.

2. Description of the Related Art

In general, digital cameras or camcorders use an image sensor such as a charge coupled device (CCD) or a complementary metal oxide semiconductor (CMOS), instead of film. CCDs can be classified into multiple CCDs and single CCDs according to the number of colors a pixel can take. Multiple CCDs can represent more accurate brightness and colors for each pixel, when compared to a single CCD. However, to detect a color component according to a color format, multiple CCDs should use sensors that are at least three times greater in number than those used in the single CCD, causing complexity in the hardware structure and an increase in the hardware size. For this reason, the single CCD is more widely used than multiple CCDs.

In the case of the single CCD, each pixel stores color information of one channel among color information of a plurality of channels. As a result, to obtain the whole information of an image, color information of another channel, which is not stored in a pixel, should be interpolated from the information of pixels adjacent to the pixel. However, when undesired information is interpolated, the resulting image may include visually unpleasant noise or artifacts.

To remove such noise, much research has been conducted in the field of image processing. A noise-removing algorithm can be classified as a method using restoration and a method using filtering. The method using restoration leads to superior results because of being based on an accurate modeling for noise, but it imposes a heavy burden on hardware. Consequently, a method using the probabilistic characteristic of a local region, e.g., a local linear minimum mean square error (LLMMSE), is widely used. On the other hand, because of being easily implemented with hardware, the method using filtering has often been used in the field of image processing. Examples of a general filter for removing color noise include a mean filter (MF), a vector median filter (VMF), and a vector directional filter (VDF).

FIG. 1 is a view for explaining examples of an MF, a VMF, and a VDF according to prior art.

The MF takes an average of pixels in a local region. In FIG. 1,

$$the MF obtains MF = ( \frac{R 1 + R 2 + R 3}{3} , \frac{G 1 + G 2 + G 3}{3} , \frac{B 1 + B 2 + B 3}{3} ) for three$$

pixels having different directions and phases.

However, since the MF performs low pass filtering (LPF), high-frequency components required for an image as well as noise are removed, resulting in the removal of fine portions.

The median filter efficiently removes Laplacian noise, thus efficiently removing a pixel that visually stands out.

As one of median filters, the VMF outputs an intermediate value among color vectors in a local region. For example, referring to FIG. 1, the VMF outputs a color value corresponding to an intermediate color vector \vec{v₃} among color vectors \vec{v₁}, \vec{v₂}, and \vec{v₃} indicating three pixels. In other words, VMF=(R3, G3, B3).

The VDF outputs a color vector having an intermediate phase among color vectors in a local region. For example, referring to FIG. 1, the VDF outputs a color value corresponding to a color vector \vec{v₂} with an intermediate phase among color vectors \vec{v₁},\vec{v₂}, and \vec{v₃} indicating three pixels. In other words, VDF=(R2, G2, B2).

When color information of another channel, which is not stored in a pixel, is interpolated using the single CCD, color information of a G channel is larger than that of other channels. In a generally used RGB layer format, a G channel has information that is two times that of R and B channels. In a cyan/magenta/yellow/green (CMYG) format, a ratio of R:G:B=2:3:2 is established between interpolated RGB data and a G channel has information that is about 1.5 times that of the R and B channels. Thus, more accurate estimation is possible using the G channel because it has more information than other channels. However, such conventional color noise removing methods do not consider correlation between channels and the characteristic of the G channel having more information than other channels. Moreover, the conventional color noise removing methods have difficulty in removing an error resulting from a change in the ratio among color channels.

### SUMMARY OF THE INVENTION

The present invention provides a method of and apparatus for removing noise that is inherent in an image sensor and unintended color noise that is generated during color interpolation.

According to an aspect of the present invention, there is provided an apparatus for removing the color noise of input red/green/blue (RGB) data that is output from an image sensor and is then interpolated. The apparatus includes a first filtering unit, a subtracting unit, a second filtering unit, and an adding unit. The first filtering unit removes color noise from color data of a first channel among the input interpolated color data and outputs filtered color data of the first channel. The subtracting unit calculates a difference between each of input color data of a second channel and a third channel among the input interpolated color data and the filtered color data of the first channel and outputs differential images. The second filtering unit selects an intermediate differential image among the output differential images and previously filtered differential images and outputs filtered differential images. The adding unit adds the filtered color data of the first channel and the filtered differential images and outputs filtered color data of the second channel and the third channel.

According to another aspect of the present invention, there is provided a method of removing color noise of input color data that is output from an image sensor and is then interpolated. The method includes removing color noise from color data of a first channel among the input interpolated color data and outputting filtered color data of the first channel, calculating a difference between each of input color data of a second channel and a third channel among the input interpolated color data and the filtered color data of the first channel and outputting differential images, selecting an intermediate differential image among the output differential images and previously filtered differential images and outputting filtered differential images, and adding the filtered color data of the first channel and the filtered differential images and outputting filtered color data of the second channel and the third channel.

### BRIEF DESCRIPTION OF THE DRAWINGS

The above and other aspects of the present invention will become more apparent by describing in detail an exemplary embodiment thereof with reference to the attached drawings in which:

FIG. 1 is a view for explaining examples of an MF, a VMF, and a VDF according to prior art;

FIG. 2 is a schematic block diagram of an image photographing apparatus using an apparatus for removing color noise according to an exemplary embodiment of the present invention;

FIG. 3 is a detailed block diagram of the apparatus for removing color noise according to an exemplary embodiment of the present invention;

FIG. 4 is a detailed block diagram of a first filtering unit of FIG. 3;

FIG. 5 illustrates an example of a 3×3 G-channel mask processed by the first filtering unit of FIG. 3;

FIG. 6 illustrates a 3×3 G-channel mask for explaining an operation of a region determining unit of FIG. 4;

FIG. 7 illustrates region coefficients set for pixels of the 3×3 G-channel mask of FIG. 6;

FIGS. 8A and 8B illustrate images filtered by the first filtering unit of FIG. 3;

FIGS. 9A and 9B illustrate enlargements of the images shown in FIGS. 8A and 8B;

FIGS. 10A and 10B are views for explaining an operation of a second filtering unit of FIG. 3;

FIG. 11 is a flowchart illustrating a method of removing color noise according to an exemplary embodiment of the present invention; and

FIGS. 12A, 12B, 13A, 13B, 14A and 14B illustrate the results of experimenting display quality improvement in an image processed using a method of and apparatus for removing color noise according to an exemplary embodiment of_the present invention.

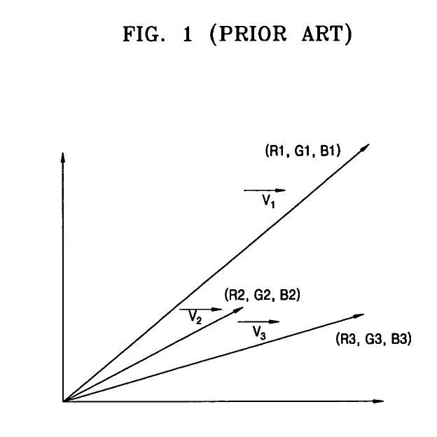

### DETAILED DESCRIPTION OF THE INVENTION

The following description will be made based on a red/green/blue (RGB) color format, but those skilled in the art can easily understand that the present invention can also be applied to other color formats such as a cyan/magenta/yellow/green (CMYG) color format and an YCbCr color format, or the like.

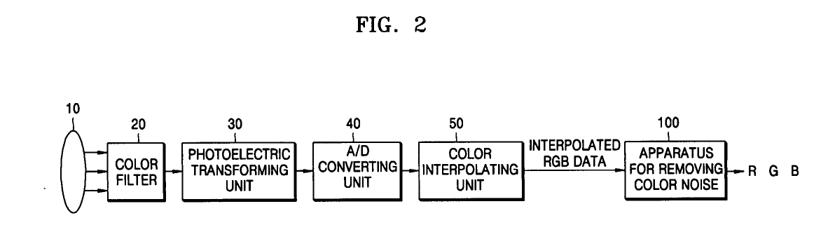

FIG. 2 is a schematic block diagram of an image photographing apparatus using an apparatus 100 for removing color noise according to an exemplary embodiment of the present invention. Referring to FIG. 2, an image of a subject input through a lens 10 passes through a color filter 20 and is then input to a photoelectric transforming unit 30. Here, a single CCD or a CMOS is used as the photoelectric transforming unit 30. The color filter 20 may be an RGB color filter arranged in a lattice pattern which filters RGB color components or a CMYG filter arranged in a lattice pattern which filters CMYG color components. An analog-to-digital (A/D) converting unit 40 converts an analog image signal output from the photoelectric transforming unit 30 into a digital signal. A color interpolating unit 50 interpolates color information of another channel, which is not stored in a pixel of the digital signal, from color information of adjacent pixels and outputs interpolated RGB data.

The apparatus 100 divides the interpolated RGB data into G data, R data, and B data and outputs filtered G′ data after independently removing color noise of color data of a G channel using a weighted mean filter (WMF). In addition, the apparatus 100 uses previously filtered differential images of adjacent pixels through a recursive median filter (RMF) to which differential images (R-G′) and (B-G′) resulting from the subtraction of the G′ data output from the WMF from the R data and the B data are input, and finally outputs R′ data, B′ data, and G′ data from which color noise is removed.

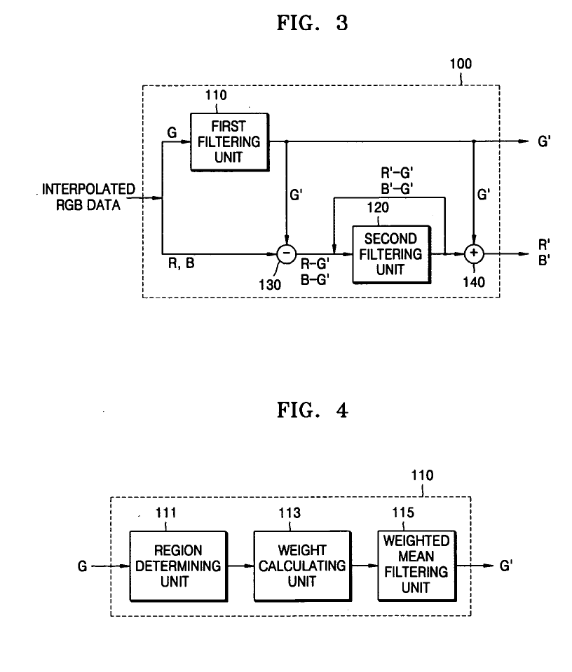

FIG. 3 is a detailed block diagram of the apparatus 100 for removing color noise according to an exemplary embodiment of the present invention.

Referring to FIG. 3, the apparatus 100 includes a first filtering unit 110, a second filtering unit 120, a subtracting unit 130, and an adding unit 140.

As described above, because the G channel has more sample data than other channels, the data of a G channel among the interpolated RGB data has less interpolation error than that of other channels. However, the interpolated data of the G channel still includes an error caused by an image sensor such as a CCD or a CMOS. Thus, noise caused by an image sensor should be additionally removed from the interpolated data of the G channel, independently of data of other channels.

Unlike a conventional filtering method, to maintain high-frequency components such as edges while removing noise, the first filtering unit 110 of the apparatus 100, as one of WMFs, determines adjacent pixels included in a region where a current pixel to be filtered exists among pixels included in a predetermined-size mask of the interpolated data of the G channel and calculates a weighted mean value using only the determined adjacent pixels for filtering, thereby outputting the filtered G′ data.

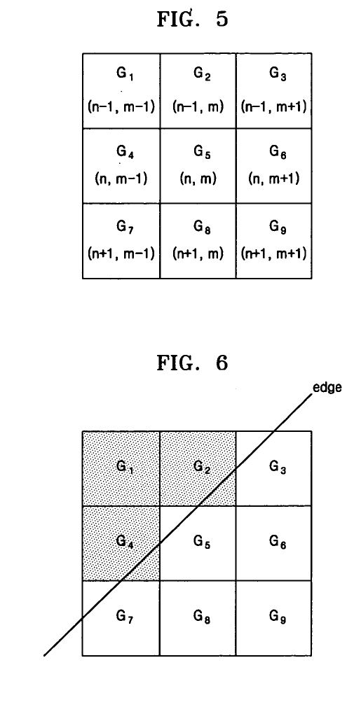

FIG. 4 is a detailed block diagram of the first filtering unit 110 of FIG. 3, and FIG. 5 illustrates an example of a 3×3 G-channel mask processed by the first filtering unit of 110 FIG. 3. Here, the G-channel mask processed by the apparatus 100 may have various sizes and take various forms without being limited to the 3×3 G-channel mask of FIG. 5.

Referring to FIG. 4, the first filtering unit 110 includes a region determining unit 111, a weight calculating unit 113, and a weighted mean filtering unit 115.

The region determining unit 111 receives input data of the G channel, determines adjacent pixels included in a region where a current pixel exists among pixels included in a predetermined-size G-channel mask. Since conventional mean filtering collectively uses non-stationary regions such as edge regions having different probabilistic characteristics for filtering of the current pixel, detailed information of the resulting image obtained after filtering is also removed. To solve the problem, the region determining unit 110 compares the absolute value of a difference between a G color value of the current pixel to be filtered and each of G color values of adjacent pixels of the current pixel to a predetermined threshold th to determine adjacent pixels to be used for filtering of the current pixel. In other words, the region determining unit 110 determines adjacent pixels to be included in a filtering region.

Hereinafter, the operation of the region determining unit 110 will be described with reference to FIG. 5. In FIG. 5, it is assumed that a position of the current pixel is (n, m), N indicates the inside of the 3×3 mask, and Gₖ (k=1, 2, . . . , 9) indicates a G color value of each pixel included in the 3×3 mask.

The region determining unit 111 determines adjacent pixels to be included in a filtering region by comparing an absolute value |Gₖ−Gᵢ| (where i=5) of a difference between a G color value G₅ of the current pixel (n, m) and each of G color values G₁, G₂, G₃, G₄, G₆, G₇, G₈, and G₉ of adjacent pixels of the current pixel (n, m) to a predetermined threshold th. Here, Gᵢ indicates a G color value of a current pixel to be filtered in a G-channel mask.

More specifically, a region coefficient Tₖ is set for each pixel by comparing the absolute value |Gₖ−Gᵢ| to the predetermined threshold th as below.
if |Gₖ−Gᵢ|<th then Tₖ=1(kεN)
else Tₖ=0(kεN) (1)

In Equation 1, the region determining unit 111 sets the region coefficient Tₖ to 1 for an adjacent pixel when the absolute value of a difference between the G color value G₅ of the current pixel (n, m) and a G color value of the adjacent pixel is less than the predetermined threshold th, so as to indicate that the adjacent pixel is included in the region where the current pixel (n, m) exists. In addition, the region determining unit 111 sets the region coefficient Tₖ to 0 for an adjacent pixel when the absolute value of a difference between the G color value G₅ of the current pixel (n, m) and a G color value of the adjacent pixel is greater than the predetermined threshold th, so as to indicate that the adjacent pixel is not included in the region where the current pixel (n, m) exists. When Tₖ=1, a pixel k is included in a filtering region. When Tₖ=0, the pixel k is not included in the filtering region.

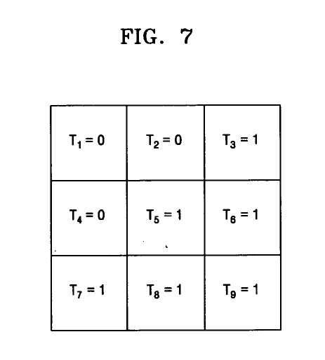

FIG. 6 illustrates a 3×3 G-channel mask for explaining the operation of the region determining unit 111 of FIG. 4, and FIG. 7 illustrates region coefficients set for pixels of the G-channel mask of FIG. 6.

Referring to FIG. 6, the region determining unit 111 calculates the absolute value |Gₖ−Gᵢ| (where i=5, k=1, 2, 3, 4, 7, 8, and 9) of a difference between the G color value G₅ of the current pixel (n, m) and each of G color values Gₖ of adjacent pixels of the current pixel (n, m) and compares the calculated absolute value |Gₖ−Gᵢ| to the predetermined threshold th, thereby determining adjacent pixels to be included in a filtering region. In the 3×3 G-channel mask shown in FIG. 6, it is assumed that the absolute values of differences between the G color value G₅ of the current pixel and G color values G₁, G₂, and G₄ are greater than the predetermined threshold th. As shown in FIG. 7, the region coefficient Tₖ is set for each pixel of FIG. 6 to determine pixels included in a region where the current pixel exists and pixels included in another region.

Referring back to FIG. 4, the weight calculating unit 113 calculates as a weight a value that is inversely proportional to the absolute value of a difference between the G color value of the current pixel and each of G color values of adjacent pixels of the current pixel. For example, the weight calculating unit 113 calculates a weight wₖ to be provided to the adjacent pixels of the current pixel as follows.

$$\{ \begin{matrix}{w}_{k} = \frac{1}{{\vert {G}_{i} - {G}_{k} \vert}^{n} + 1} & ( i \neq k , k ∈ N ) \\ {w}_{k} = 1 & ( i = k , k ∈ N )\end{matrix} \qquad ( 2 )$$

The weighted mean filtering unit 115 calculates and outputs a filtered G color value Gi′ of the current pixel using the region coefficient Tk set by the region determining unit 111 and the weight wk calculated by the weight calculating unit 113 as follows.

$${G}_{i}^{′} = \frac{{\sum }_{k ∈ N}^{} ( {w}_{k} \times {T}_{k} ) \times {G}_{k}}{{\sum }_{k ∈ N}^{} ( {w}_{k} \times {T}_{k} )} \qquad ( 3 )$$

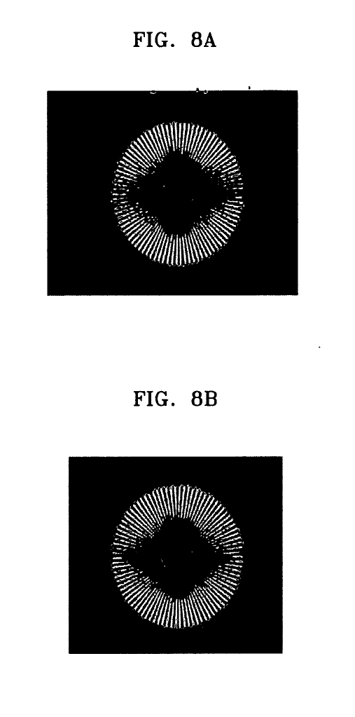

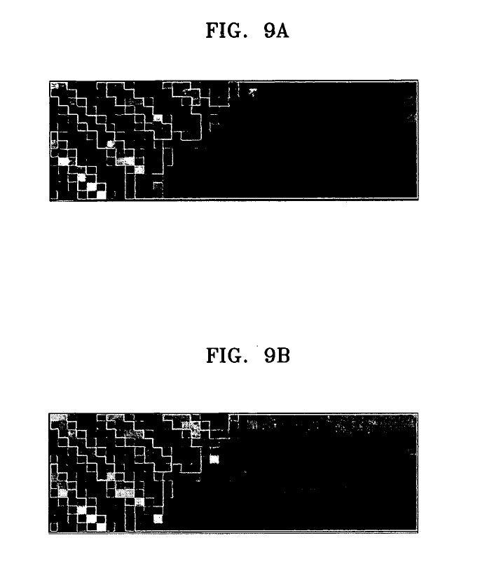

FIGS. 8A and 8B illustrate images filtered by the first filtering unit 110 of FIG. 3, and FIGS. 9A and 9B illustrate enlargements of the images shown in FIGS. 8A and 8B. Here, FIG. 8A illustrates an image obtained by color-interpolating image data output from a CMYG-format CCD image sensor using interlaced scanning according to a conventional method, and FIG. 8B illustrates an image obtained by filtering the image of FIG. 8A with the first filtering unit 110.

In comparison between enlargements of the two images as shown in FIGS. 9A and 9B, the first filtering unit 110 removes noise in a flat region without causing damage to detailed information that is inherent in an image in an edge region.

Referring back to FIG. 3, the subtracting unit 130 calculates a difference between the interpolated R data and B data and the G′ data filtered by the first filtering unit 110 and outputs the differential images (R-G′) and (B-G′).

The differential images (R-G′) and (B-G′) output from the subtracting unit 130 and previously filtered differential images (R′-G′) and (B′-G′) are input to the second filtering unit 120 in a recursive way. As one of RMFs, the second filtering unit 120 removes color noise included in such differential images.

As mentioned above, unlike the G channel, the R channel and the B channel include both noise caused by an image sensor and noise generated during interpolation. Since the density of an image sensor corresponding to G channel is high, G channel noise generated during interpolation is relatively small. In addition, since noise caused by the image sensor is removed by the first filtering unit 110, it is not necessary to update the filtered G′ data output from the first filtering unit 110. Thus, the second filtering unit 120 removes color noise of a differential image using correlation between the G channel and the R channel and between the G channel and the B channel.

More specifically, the second filtering unit 120 uses the differential images (R-G′) and (B-G′) to update the R channel and the B channel on the assumption that differences or ratios between color channels of an image are constant in similar regions. In other words, when RGB values of three pixels in similar regions are (R₁, B₁, G₁), (R₂, B₂, G₂), and (R₃, B₃, G₃), ratios between the R channel and the G channel and between the B channel and the G channel are as follows.

$$\begin{matrix}\frac{{R}_{1}}{{G}_{1}} ≅ \frac{{R}_{2}}{{G}_{2}} ≅ \frac{{R}_{3}}{{G}_{3}} ≅ {K}^{′} & ( 4 ) \\ \frac{{B}_{1}}{{G}_{1}} ≅ \frac{{B}_{2}}{{G}_{2}} ≅ \frac{{B}_{3}}{{G}_{3}} ≅ {K}^{″} & ( 5 )\end{matrix}$$

In other words, it can be seen that color ratios between R channels and G channels of pixels in similar regions are similar to one another. In addition, differential images of pixels in similar regions are also similar to one another as follows.
R₁−G₁≅R₂−G₂≅R₃−G₃≅K′″
B₁−G₁≅B₂−G₂≅B₃−G₃≅K″″ (6)

Thus, the second filtering unit 120 removes color noise of differential images using correlation between the G channel and the R channel and between the G channel and the B channel.

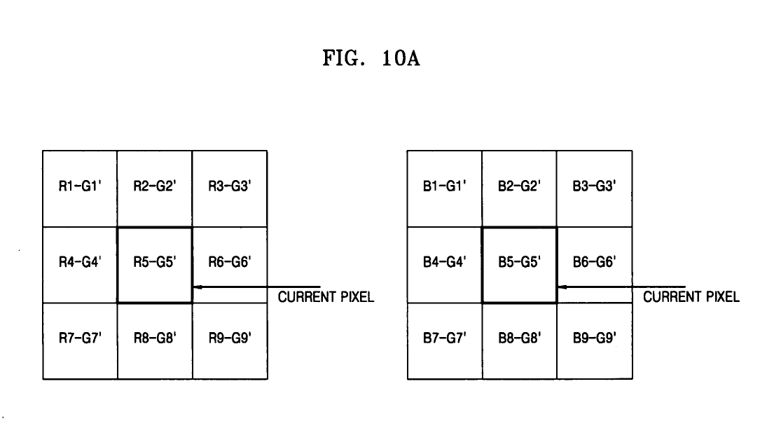

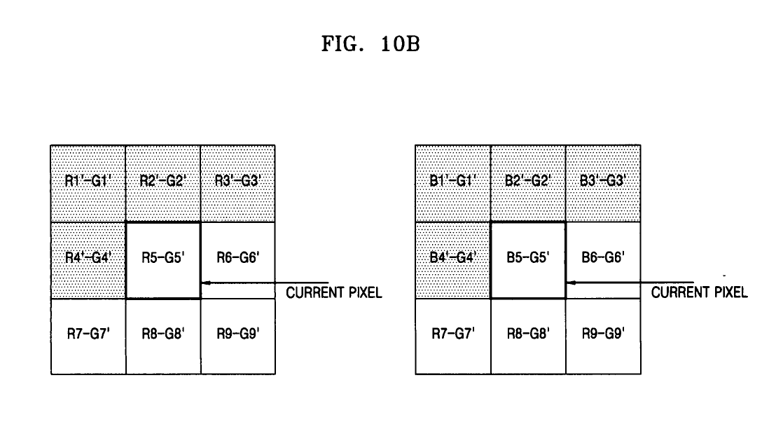

FIGS. 10A and 10B are views for explaining the operation of the second filtering unit 120 of FIG. 3.

The second filtering unit 120 receives the differential images (R-G′) and (B-G′) output from the subtracting unit 130 and outputs an intermediate differential image among differential images of pixels included in a predetermined-size differential image mask. In particular, the second filtering unit 120 can effectively remove color noise in a recursive way in which previously filtered and output differential images (R′-G′) and (B′-G′) are input back to the second filtering unit 120. As shown in FIG. 10B, shaded pixels (R1′-G1′), (R2′-G2′), (R3′-G3′), and (R4′-G4′) indicate previously median-filtered values. Referring to FIG. 10A, the filtered differential images (R′-G′) and (B′-G′) output from the second filtering unit 120 are as follows.
R′-G′=Median{(R1′-G1′),(R2′-G2′),(R3′-G3′),(R4′-G4′),(R5′-G5),(R6′-G6),(R7′-G7),(R8′-G8),(R9′-G9)}
B′-G′=Median{(B1′-G1′),(B2′-G2′),(B3′-G3′),(B4′-G4′),(B5′-G5),(B6′-G6),(B7′-G7),(B8′-G8),(B9′-G9)} (7)

Referring back to FIG. 3, the adding unit 140 adds the filtered G′ data output from the first filtering unit 110 and the filtered differential images (R′-G′) and (B′-G′) output from the second filtering unit 120 and outputs finally filtered R′ and B′ data.

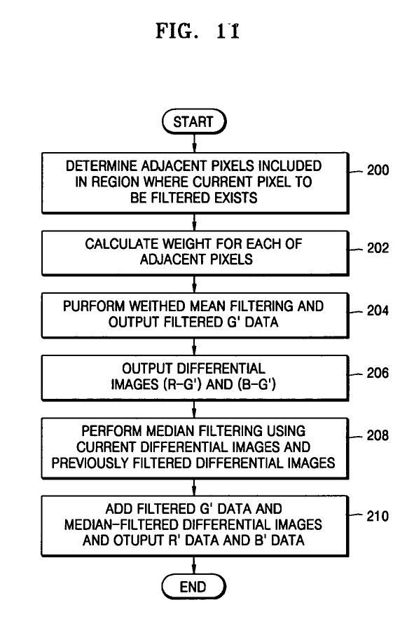

FIG. 11 is a flowchart illustrating a method of removing color noise according to an exemplary embodiment of the present invention.

Referring to FIG. 11, adjacent pixels included in a region where a current pixel to be filtered exists are determined among pixels included in a predetermined-size G-channel mask in input RGB data that is output from an image sensor such as a CCD and is then interpolated, in operation 200. As mentioned above, the adjacent pixels included in the region where the current pixel exists are used to filter the current pixel. As in Equation 1, the absolute value of a difference between a G color value of the current pixel and each of G color values of the determined adjacent pixels is compared to the predetermined threshold th. The region coefficient Tₖ is set to 1 for an adjacent pixel when the absolute value of the difference is less than the predetermined threshold th, so as to indicate that the adjacent pixel is included in the region where the current pixel exists. The region coefficient Tₖ is set to 0 for an adjacent pixel when the absolute value of the difference is greater than the predetermined threshold th, so as to indicate that the adjacent pixel is not included in the region where the current pixel exists.

Next, as in Equation 2, a value that is inversely proportional to the absolute value of a difference between a G color value of the current pixel and each of G color values of the determined adjacent pixels within a predetermined-size mask from the current pixel is calculated as a weight wk in operation 202.

As in Equation 3, a weighted mean filtering is performed using the region coefficient Tₖ set for each of the adjacent pixels in operation 200 and the weight wₖ of each of the adjacent pixels calculated in operation 202, thereby calculating and outputting filtered G′ data of the current pixel in operation 204.

In next operation 206, differential images (R-G′) and (B-G′) are output by calculating differences between input R data and the filtered G′ data output in operation 204 and between input B data and the filtered G′ data output in operation 204.

Median filtering is performed in operation 208 using the differential images (R-G′) and (B-G′) output in operation 206 and previously filtered differential images (R′-G′) and (B′-G′) input in a recursive way. Here, the result of median filtering is an intermediate differential image among differential images between pixels included in a predetermined-size differential image mask of the differential images (R-G′) and (B-G′) and the previously filtered and output differential images (R′-G′) and (B′-G′).

In operation 210, the filtered G′ data output in operation 204 and the filtered differential images (R′-G′) and (B′-G′) output in operation 206 are added and thus, finally filtered R′ data and B′ data are output.

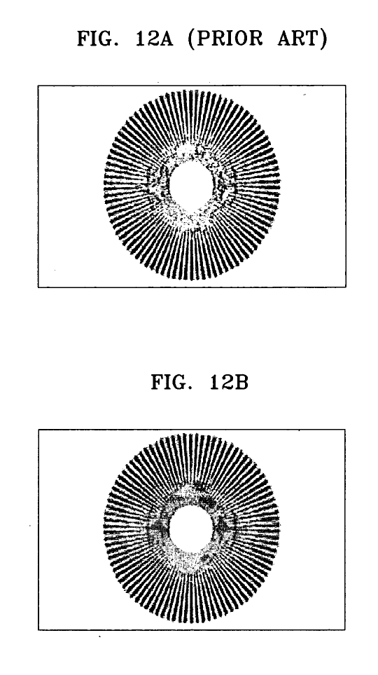

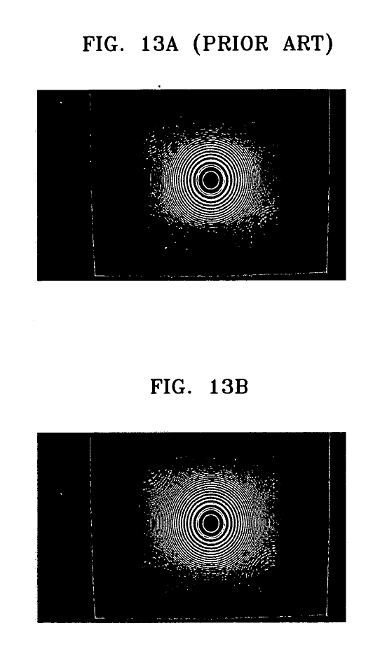

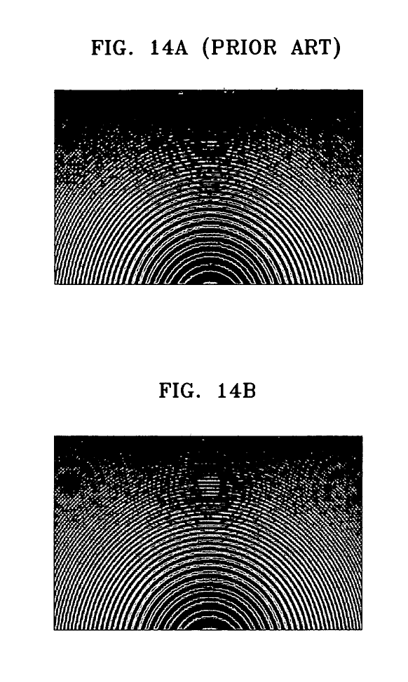

FIGS. 12A through 14B illustrate the results of experimenting display quality improvement in an image processed using the method of and apparatus for removing color noise according to an exemplary embodiment of the present invention. Here, FIG. 12A illustrates a radial image obtained by color-interpolating color image data obtained by a single CCD, and FIG. 12B illustrates an image obtained after filtering the image of FIG. 12A. FIG. 13A illustrate a circle image obtained by color-interpolating color image data obtained by a single CCD, and FIG. 13B illustrates an image obtained after filtering the image of FIG. 13A. FIGS. 14A and 14B illustrate enlargements of the images of FIGS. 13A and 13B.

Referring to FIGS. 12A, 13A, and 14A, the original images before filtered according to an exemplary embodiment of the present invention have many thin edges, resulting in the generation of much color noise during interpolation. However, referring to FIGS. 12B, 13B, and 14B, it can be seen that much of color noise around edges is removed after filtering according to an exemplary embodiment of the present invention.

As described above, according to the present invention, noise caused by an image sensor is removed and unintended color noise generated during color interpolation is effectively removed based on correlation between color channels. Thus, when the present invention is applied to digital still cameras (DSC) or camcorders, noise-removed clear images can be provided.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for removing color noise, the apparatus comprising:
a first filtering unit which removes color noise from color data of a first channel among input interpolated color data, and outputs filtered color data of the first channel;
a subtracting unit which calculates a difference between color data of a second channel among the input interpolated color data and the filtered color data of the first channel, and a difference between color data of a third channel among the input interpolated color data and the filtered color data of the first channel, and outputs differential images corresponding to the differences;
a second filtering unit which determines an intermediate differential image from the output differential images and previously filtered differential images, and outputs current filtered differential images; and
an adding unit which adds the filtered color data of the first channel and the filtered differential images, and outputs filtered color data of the second channel and filtered color data of the third channel.

2. The apparatus of claim 1, wherein the first filtering unit comprises:
a region determining unit which receives the color data of the first channel and sets a region coefficient for each adjacent pixel included in a predetermined-size first channel mask according to whether an adjacent pixel is included in a region where a current pixel to be filtered exists;
a weight calculating unit which calculates a weight value for each adjacent pixel that is inversely proportional to an absolute value of a difference between a color value of the first channel of the current pixel and a corresponding one of the adjacent pixels in the predetermined-size first channel mask; and
a weighted mean filtering unit which calculates a weighted mean value for the current pixel using the region coefficient set by the region determining unit and the weight calculated by the weight calculating unit, and outputs filtered color data of the first channel for the current pixel based on the weighted mean value.

3. The apparatus of claim 2, wherein the region determining unit sets the region coefficient by comparing the color data of a first channel to a threshold.

4. The apparatus of claim 2, wherein the region determining unit sets the region coefficient to 1 for an adjacent pixel if an absolute value of a difference between a color value of the current pixel and a color value of the adjacent pixel is less than a threshold, so as to indicate that the adjacent pixel is included in a region where the current pixel exists and sets the region coefficient to 0 for an adjacent pixel if the absolute value of a difference between the color value of the current pixel and a color value of the adjacent pixel is greater than the threshold, so as to indicate that the adjacent pixel is not included in the region where the current pixel exists.

5. The apparatus of claim 2, wherein the weight calculating unit calculates the weight value wₖ for each of the adjacent pixels according to the following equation:
$$\{ \begin{matrix}{w}_{k} = \frac{1}{{\vert {G}_{i} - {G}_{k} \vert}^{N} + 1} & ( i \neq k , k ∈ N ) \\ {w}_{k} = 1 & ( i = k , k ∈ N )\end{matrix} ,$$
where Gₖ indicates color values of adjacent pixels included in the predetermined-size first channel mask, Gᵢ indicates the color value of the current pixel, and N indicates the inside of the predetermined-size first channel mask.

6. The apparatus of claim 2, wherein the weighted mean filtering unit calculates and outputs the filtered color data of the first channel Gᵢ′ for the current pixel using
$${G}_{i}^{′} = \frac{{\sum }_{k ∈ N}^{} ( {w}_{k} \times {T}_{k} ) \times {G}_{k}}{{\sum }_{k ∈ N}^{} ( {w}_{k} \times {T}_{k} )} ,$$
where Gₖ indicates color values of adjacent pixels included in the predetermined-size first channel mask, Gᵢ indicates the color value of the current pixel, and N indicates the inside of the predetermined-size first channel mask.

7. The apparatus of claim 2, wherein the predetermined-size first channel mask has a size of three pixels by three pixels.

8. The apparatus of claim 1, wherein the first channel is a G channel, the second channel is one of an R channel and a B channel, and the third channel is the other one of the R channel and the B channel.

9. A method of removing color noise, the method comprising:
removing color noise from color data of a first channel among the input interpolated color data and outputting filtered color data of the first channel;
calculating a difference between color data of a second channel among the input interpolated color data and the filtered color data of the first channel, and a difference between a third channel among the input interpolated color data and the filtered color data of the first channel, and outputting differential images corresponding to the differences;
determining an intermediate differential image from the output differential images and previously filtered differential images, and outputting filtered differential images; and
adding the filtered color data of the first channel and the current filtered differential images and outputting filtered color data of the second channel and filtered color data of the third channel.

10. The method of claim 9, wherein the outputting of the filtered color data of the first channel comprises:
receiving the color data of the first channel and setting a region coefficient for each adjacent pixel included in a predetermined-size first channel mask according to whether an adjacent pixel is included in a region where a current pixel to be filtered exists;
calculating a weight value that is inversely proportional to an absolute value of a difference between a color value of the first channel of the current pixel and each a corresponding one of the adjacent pixels in the predetermined-size first channel mask; and
calculating a weighted mean value for the current pixel using the set region coefficient and the calculated weight, and outputting filtered color data of the first channel for the current pixel based on the weighted mean value.

11. The method of claim 10, wherein the region coefficient is set by comparing the color data of the first channel to a threshold.

12. The method of claim 10, wherein the region coefficient is set to 1 for an adjacent pixel if an absolute value of a difference between a color value of the current pixel and a color value of the adjacent pixel is less than a predetermined threshold, so as to indicate that the adjacent pixel is included in a region where the current pixel exists and the region coefficient is set to 0 for an adjacent pixel if the absolute value of a difference between the color value of the current pixel and a color value of the adjacent pixel is greater than the predetermined threshold, so as to indicate that the adjacent pixel is not included in the region where the current pixel exists.

13. The method of claim 10, wherein the weight value wₖ for each of the adjacent pixels is calculated using
$$\{ \begin{matrix}{w}_{k} = \frac{1}{{\vert {G}_{i} - {G}_{k} \vert}^{n} + 1} & ( i \neq k , k ∈ N ) \\ {w}_{k} = 1 & ( i = k , k ∈ N )\end{matrix} ,$$
where Gₖ indicates color values of adjacent pixels included in the predetermined-size first channel mask, Gᵢ indicates the color value of the current pixel, and N indicates the inside of the predetermined-size first channel mask.

14. The method of claim 10, wherein the filtered color data of the first channel Gᵢ′ for the current pixel is calculated and output using
$${G}_{i}^{′} = \frac{{\sum }_{k ∈ N}^{} ( {w}_{k} \times {T}_{k} ) \times {G}_{k}}{{\sum }_{k ∈ N}^{} ( {w}_{k} \times {T}_{k} )} ,$$
where Gₖ indicates color values of adjacent pixels included in the predetermined-size first channel mask, Gᵢ indicates the color value of the current pixel, and N indicates the inside of the predetermined-size first channel mask.

15. The method of claim 10, wherein the predetermined-size first channel mask has a size of three pixels by three pixels.

16. The method of claim 9, wherein the first channel is a G channel, the second channel is one of an R channel and a B channel, and the third channel is the other one of the R channel and the B channel.
